(19) United States
(12) Patent Application Publication
(10) Pub. No.: US 2019/0100073 A1
(43) Pub. Date: Apr. 4, 2019

(54) DUCT ASSEMBLY FOR A WORK VEHICLE

(71) Applicant: CNH INDUSTRIAL AMERICA LLC, New Holland, PA (US)

(72) Inventors: John Francis Link, Calumet City, IL (US); Shane M. Scott, Bolingbrook, IL (US); Phetsamone Siriphong, South Elgin, IL (US); Thomas Lee Howard, Chicago, IL (US)

(73) Assignee: CNH INDUSTRIAL AMERICA LLC

(21) Appl. No.: 15/722,851

(22) Filed: Oct. 2, 2017

(51) Int. Cl. B60H 1/00; B62D 25/18

(52) U.S. Cl. CPC B60H 1/00271; B60R 16/023; B60H 1/00564; B62D 25/18

(57) ABSTRACT

A duct assembly for a work vehicle includes a fender duct that includes a body that extends between a first opening and a second opening. Furthermore, the fender duct flows fluid between the first opening and the second opening. The fender duct is positioned on a bottom side of the work vehicle and radially outward from a wheel of the work vehicle. The duct assembly for the work vehicle further includes an armor assembly positioned radially outward from the fender duct, such that the armor assembly forms a housing around the fender duct.

### BACKGROUND

The present disclosure relates generally to a duct assembly for a work vehicle.

Certain work vehicles (e.g., tractors, harvesters, skid steers, etc.) may be used to tow or support tools to plow a field, till land, excavate soil, or accomplish other ground-working operations. In some instances, the wheels of the work vehicles may expel debris and dirt. As a result, debris and dirt from the work environment may come into contact with the various sensitive components (e.g., internal oiled components, electrical wiring, etc.) of the work vehicle. The dirt and debris may increase maintenance costs (e.g., by increasing the rate of periodic cleaning).

### BRIEF DESCRIPTION

In one embodiment, a duct assembly for a work vehicle includes a fender duct that includes a body that extends between a first opening and a second opening. Furthermore, the fender duct flows fluid between the first opening and the second opening. The fender duct is positioned on a bottom side of the work vehicle and radially outward from a wheel of the work vehicle. The duct assembly for the work vehicle further includes an armor assembly positioned radially outward from the fender duct, such that the armor assembly forms a housing around the fender duct.

In another embodiment, a duct assembly for a work vehicle includes a fender well that forms a portion of a bottom side of a chassis of the work vehicle, such that the bottom side of the chassis includes electrical connectors that are positioned forward of the fender well. The duct assembly further includes a fender duct that includes a body that extends between a first opening and a second opening, such that the fender duct flows fluid between the first opening and the second opening, and the fender duct is positioned on a bottom side of a chassis of the work vehicle and radially outward from a wheel of the work vehicle. The duct assembly also includes an inlet duct coupled to the first opening of the fender duct and an outlet duct coupled to the second opening of the fender duct.

In a further embodiment, a duct assembly for a work vehicle includes a fender well that includes a portion of a bottom side of a chassis of the work vehicle, such that the bottom side of the chassis includes electrical connectors positioned forward of the fender well. The duct assembly further includes a fender duct that includes a body that forms a portion of the fender well, extends between a first opening and a second opening, and flows fluid between the first opening and the second opening. Furthermore, the fender duct is positioned on a bottom side of a chassis of the work vehicle and radially outward from a wheel of the work vehicle. The duct assembly further includes an inlet duct coupled to the first opening of the fender duct and an outlet duct coupled to the second opening of the fender duct.

### DRAWINGS

These and other features, aspects, and advantages of the present disclosure will become better understood when the following detailed description is read with reference to the accompanying drawings in which like characters represent like parts throughout the drawings, wherein:

FIG. 1 is a perspective view of an embodiment of a work vehicle that may include a duct assembly;

FIG. 2 is a perspective view of an embodiment of a work vehicle, including a duct assembly;

FIG. 3 is a perspective view of an embodiment of a portion of the work vehicle of FIG. 2, including the duct assembly;

FIG. 4 is a top view of an embodiment of internal components of the work vehicle of FIG. 2, including an outlet duct of the duct assembly;

FIG. 5 is a front view of the internal components of FIG. 4, including the duct assembly;

FIG. 6 is a perspective view of an embodiment of the duct assembly;

FIG. 7 is an exploded view of the duct assembly of FIG. 6; and

FIG. 8 is a perspective view of an embodiment of a fender duct of the duct assembly of FIG. 6.

### DETAILED DESCRIPTION

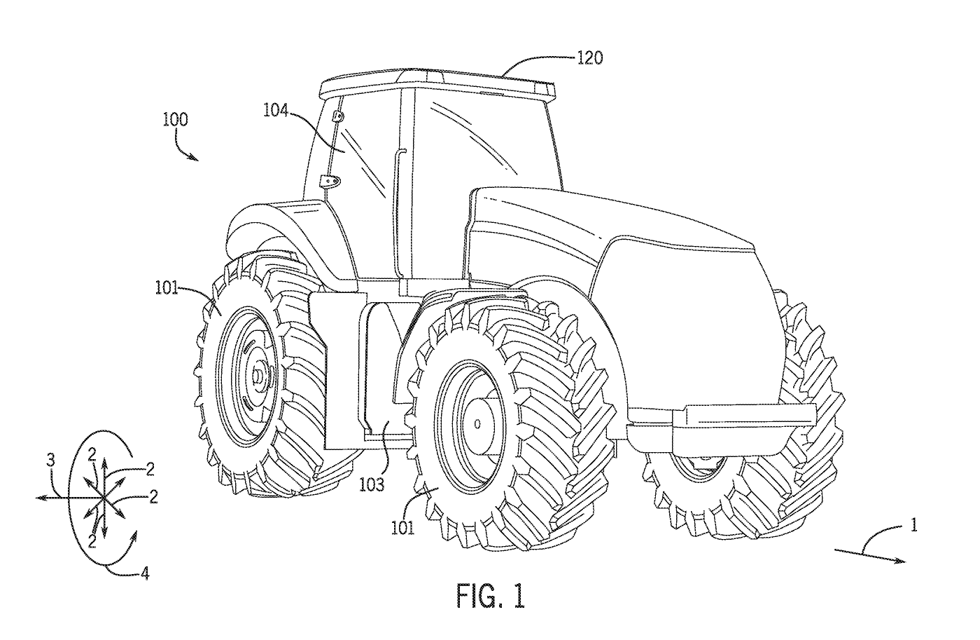

Turning to the drawings, FIG. 1 is a perspective view of an embodiment of a work vehicle 100 that may include a duct assembly. In the illustrated embodiment, the work vehicle 100 is a tractor. However, it should be appreciated that the duct assembly disclosed herein may be utilized on other work vehicles, such as but not limited to on-road trucks, skid steers, harvesters, and construction equipment. In the illustrated embodiment, the work vehicle 100 includes a cab 120 and a chassis 103. In certain embodiments, the chassis 103 may house a motor (e.g., diesel engine, etc.), a hydraulic system (e.g., including a pump, valves, reservoir, etc.), and other components (e.g., an electrical system, a cooling system, etc.) that facilitate operation of the work vehicle. In addition, the chassis 103 may support the cab 120 and wheels 101. The wheels 101 may rotate in a circumferential direction 4 to cause the forward linear movement of the work vehicle 100 along a direction/axis of travel 1. It should be noted, that the radial direction 2 may refer to any direction radially outward from the center of the coordinate system, which includes the circumferential direction/axis 4. Furthermore, the coordinate system includes a lateral direction/axis 3, which is perpendicular to the plane of the circumferential direction 4. While the illustrated work vehicle 100 includes wheels 101, it should be appreciated that in alternative embodiments, the work vehicle may tracks or a combination of wheels and tracks that similarly rotate in the circumferential direction 4 to cause the work vehicle to advance along the direction/axis of travel 1.

The cab 120 may house an operator of the work vehicle 100. Accordingly, various controls, such as the illustrated hand controller 105, are positioned within the cab 120 to facilitate operator control of the work vehicle 100. For example, the controls may enable the operator to control rotational speed of the wheels 101, thereby facilitating adjustment of the speed and/or the direction of the work vehicle 100. In the illustrated embodiment, the cab 120 also includes a door 104 to facilitate ingress and egress of the operator from the cab 120.

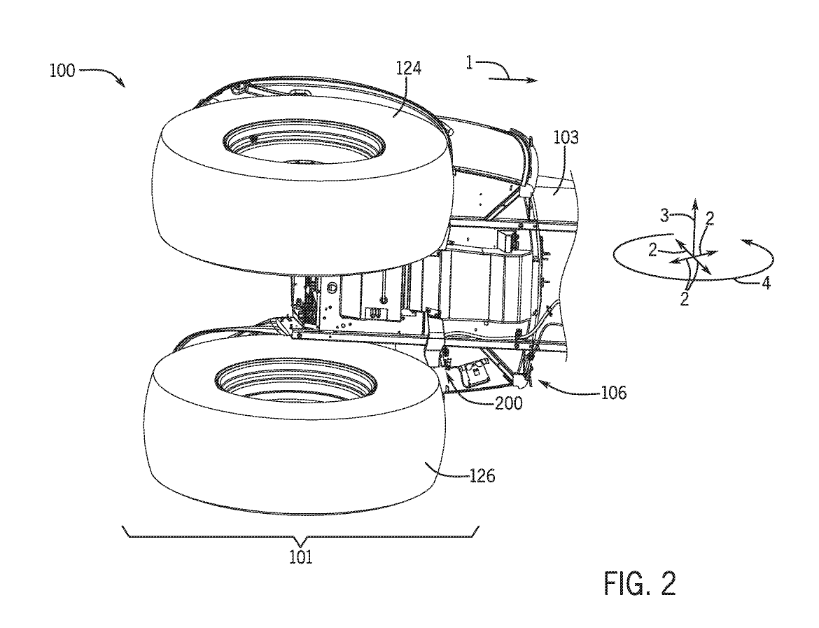

FIG. 2 is a perspective view of an embodiment of the work vehicle 100, including a duct assembly 200. As illustrated, the duct assembly 200 is located on the bottom side of the work vehicle forward of the rear right wheel 124. Accordingly, the duct assembly 200 is positioned on the bottom side of the mid-portion 106 of the chassis 103. In the illustrated embodiment, the duct assembly 200 is positioned radially outward (e.g., along the radial direction 2) from the rear right wheel 124. However, in alternative embodiments, the duct assembly 200 may be positioned rearward or forward (e.g., relative to the direction of travel 1) of any of the other wheels. That is, the duct assembly 200 may be positioned near (e.g., forward or rearward) the front right wheel, the front left wheel, the rear left wheel 126, or any combination thereof. In further embodiments, for work vehicles including tracks (e.g., instead of wheels 101), a duct assembly 200 may be positioned on the bottom side of the work vehicle rearward and/or forward of at least one track of work vehicle.

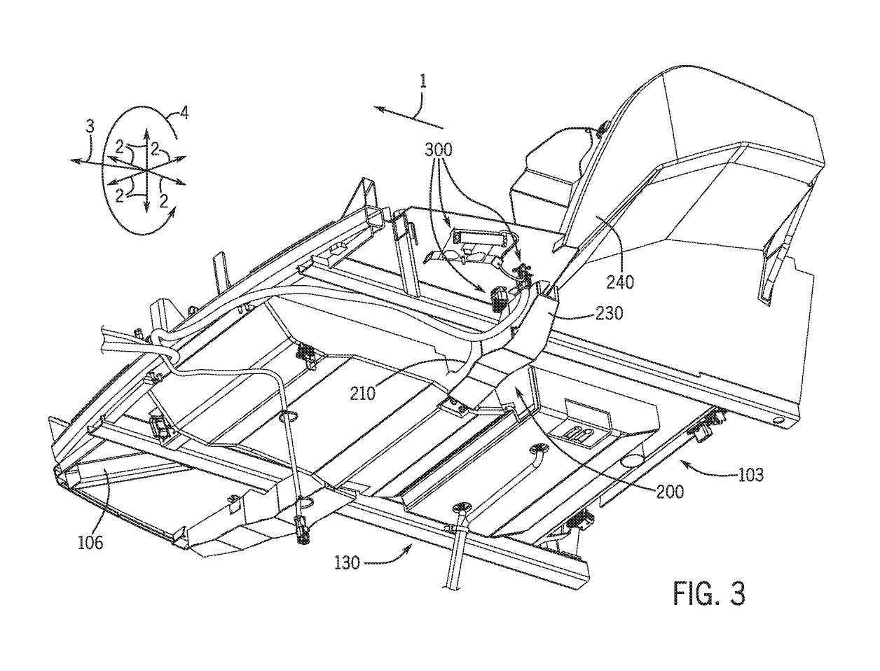

FIG. 3 is a perspective view of an embodiment of a portion of the work vehicle of FIG. 2, including the duct assembly 200. As mentioned above and as shown in the illustrated embodiment, the duct assembly 200 is positioned on the bottom side 130 of the chassis 103 of the work vehicle. In certain embodiments, the duct assembly 200, includes a fender duct 210, an armor assembly 230, a fender well 240, electrical connectors 300, or any combination thereof. The fender duct 210 may block debris (e.g., expelled by the wheels or tracks), such as mud, rocks, dirt, and the like, from coming into contact with the electrical connectors 300. The electrical connectors 300 may include inductors, sensors, power lines, electrical wiring, transceiver, and/or the like. In certain embodiments, the electrical connectors 300 may be on the inside of the mid-portion 106 of the chassis 103 of the work vehicle and/or on the outside of the chassis 103 of the work vehicle, exposed to the ambient environment under the work vehicle, as illustrated in the current embodiment. As such, having the duct assembly 200 disposed between the electrical connectors and the wheels may enhance the longevity of the electrical connectors 300, for example, by blocking debris expelled by the wheel(s).

Furthermore, the fender duct 210 may receive fluid, such as air, from an inlet duct and direct the fluid toward an outlet duct. Moreover, the fender well 240 of the duct assembly 200 may partially house the outlet duct and follow the circumference of the wheel (e.g., along circumferential direction 4). Accordingly, the fender well 240 is positioned about the wheel along the radial axis 2 of the wheel. As mentioned below, the fender well 240 may provide partial housing for the outlet duct, which may receive fluid from the fender duct 210.

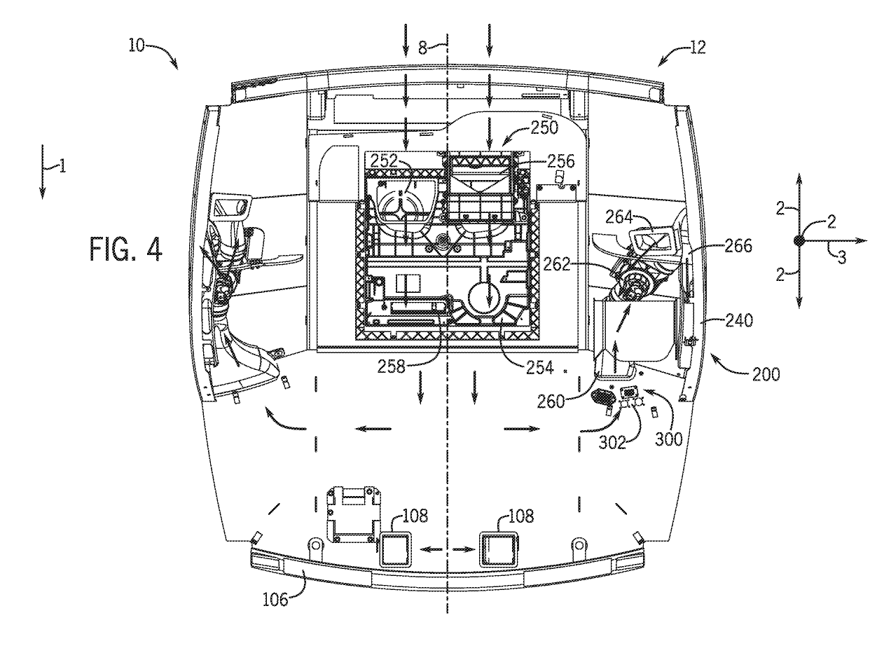

FIG. 4 is a top view of an embodiment of internal components of the work vehicle of FIG. 2, including an outlet duct 260 of the duct assembly 200. For reference, centerline 8 is included, such that the centerline 8 is parallel to the direction of travel 1 of the work vehicle. Moreover, the centerline 8 divides the work vehicle into a left section 12 and a right section 10. While only the duct assembly 200 located on the left section 12 of the work vehicle is described in detail below, it should be noted that in additional embodiments, a duct assembly may also be located on the right section 10 of the work vehicle. As shown in the illustrated embodiment, electrical connectors 300 are located forward of the fender well 240. While there may also be electrical connectors on the bottom side of the work vehicle, a portion 302 of the electrical connectors 300 are located inside the chassis 103 (e.g., on the top side of the mid-portion 106 chassis).

It should be noted that in FIG. 4, and hereinafter, arrows may be included to illustrate the flow path of the fluid (e.g., air) being circulated within the work vehicle and its components. Moreover, the illustrated work vehicle includes an HVAC (i.e., heating, ventilation, and air conditioning) system 250. The HVAC system 250 may receive ambient air via an HVAC inlet 252 and may receive recirculated air from an HVAC opening 256, as indicated by the arrows illustrating the flow path of the fluid. Once received by the HVAC system 250, the fluid (e.g., ambient air and/or recirculated air) may be heated or cooled to a target temperature before being expelled out through the HVAC outlet 258 by the fan 254. As described in detail below, once the fluid (e.g., air) exits the HVAC system 250, the fluid flows to the duct assembly by flowing to an inlet duct, a fender duct, and an outlet duct 260. Fluid flows from the outlet duct 260 to a valve 262, which may send the fluid to a primary path 264 and/or a secondary path 266, as illustrated by the arrows indicating the flow path of the fluid. In certain embodiments, the valve may control fluid flow to the primary path 264 to enable fluid to the cab of the work vehicle and to enable fluid to flow to internal components (e.g., engine, battery, etc.) of the work vehicle for ventilation of the internal components. Further, the valve may control fluid flow through the secondary path 266 to route fluid along the inside of the fender well 240 toward a secondary element. The secondary element may include a window defrost system, a heating/cooling system of the seat of the work vehicle, and the like.

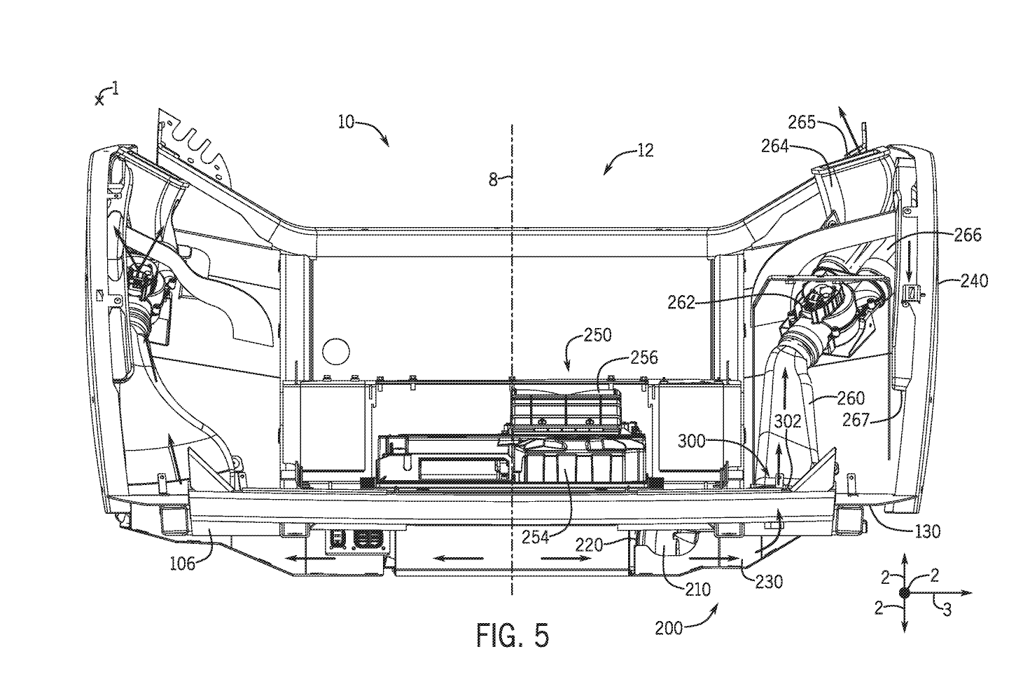

FIG. 5 is a front view of the internal components of FIG. 4, including the duct assembly 200. For context, the direction of travel of the work vehicle is indicated by direction 1, which faces into the page. For reference, centerline 8 divides the work vehicle into the right section 10 and the left section 12, such that the duct assembly 200 is positioned on the left section 12. As mentioned above, once the HVAC system 250 receives fluid (e.g., ambient air and/or recirculated air), the fluid is expelled via the fan 254 to an inlet duct 220. The inlet duct 220 couples to a first opening of the fender duct 210, and the inlet duct 220 may direct the fluid along a substantially lateral direction 3 to the fender duct 210. In the illustrated embodiment, the duct assembly 200 includes a fender duct 210 and an armor assembly 230 that forms a housing around a portion of the fender duct 210 along the circumferential axis 4 of the fender duct 210. In alternative embodiments, the duct assembly 200 may not include the armor assembly 230.

Furthermore, in the illustrated embodiment, the fender duct 210 may expel the fluid along the upward radial direction 2 out of a second opening of the fender duct 210 to the outlet duct 260. As mentioned above, the outlet duct 260 directs the fluid towards the valve 262, and the valve 262 may direct the flow of fluid to a primary path 264, a secondary path 266, or any combination thereof. Fluid exits the primary path 264 out of a primary path opening 265, and fluid may exit the secondary path 266 out of a secondary path opening 267. As illustrated, the secondary path may be housed inside the fender well 240. In addition, the portion 302 of the electrical connectors 300 inside the mid-portion 106 of the chassis 103, may be separated from the external environment of the work vehicle by the chassis 103. In further embodiments, there may also be electrical connectors may be positioned under the chassis 103, exposed to the external environment of the work vehicle.

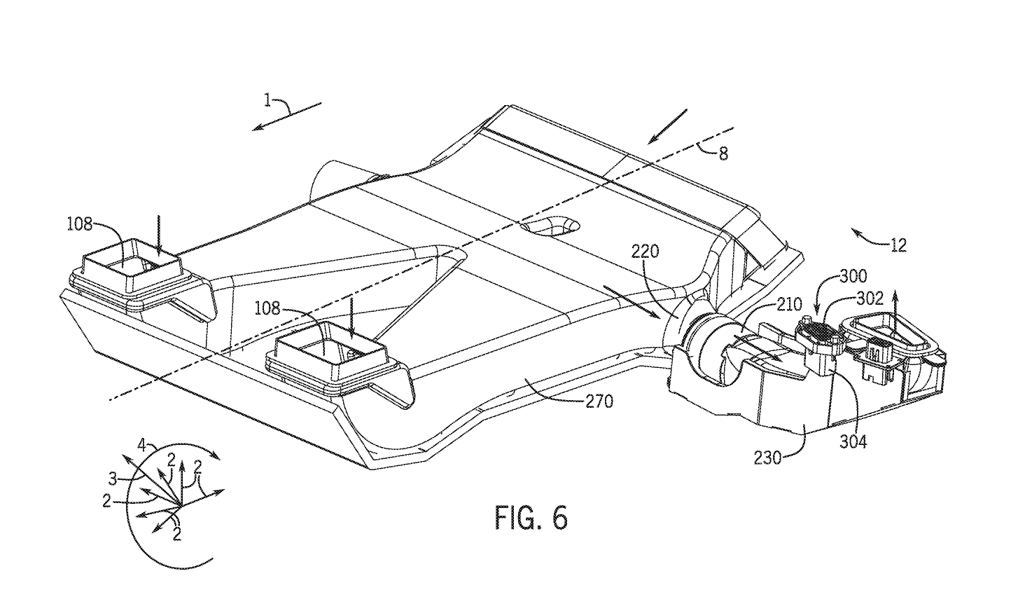

FIG. 6 is a perspective view of an embodiment of the duct assembly 200. For reference, the centerline 8 is aligned substantially parallel to the direction of travel 1, such that the centerline 8 separates the right section 10 from the left section 12 of an HVAC compartment 270. Both the right section 10 and the left section 12 include a respective opening 108 configured to receive circulated fluid (e.g., air) from the cabin, which is directed to the HVAC opening 256. As illustrated, the duct assembly 200 is positioned on the left section 12 of the HVAC compartment 270. As mentioned above, the duct assembly 200 includes a fender duct 210, which is configured to receive fluid from an inlet duct 220 and to direct the fluid toward an outlet duct. In the illustrated embodiment, the armor assembly 230 extends along the length of the fender duct 210 along the lateral direction 3, such that the armor assembly 230 forms a housing, extending in the circumferential direction 4, around the fender duct 210. While in the illustrated embodiment, the top portion of the fender duct 210 is exposed (e.g., such that it is not housed by a portion of the armor assembly 230), in further embodiments, the top portion of the fender duct 210 may be housed by the armor assembly 230. In alternative embodiments, the fender duct 210 may not be housed in the armor assembly 230, such that the duct assembly 200 does not include the armor assembly 230.

Furthermore, portion 302 of the electrical connectors 300 inside the mid-portion of the chassis (e.g., inside the body of the work vehicle) and a portion 304 outside of the chassis (e.g., outside the body of the work vehicle exposed to the environment) may respectively include electrical wiring, inductors, capacitors, transistors, and the like. In certain embodiments, there may be an opening in the chassis that facilitates passage of the electrical connectors 300 through the chassis, such that the portion 302 inside the mid-portion of the chassis is above the opening in the chassis, and the portion 304 outside the mid-portion of the chassis is below the opening in the chassis. In further embodiments, electrical connectors 300 may include more than one portion 302 inside the mid-portion of the chassis and/or may include more than one portion 304 outside the chassis. In further embodiments, either portion of the electrical connectors 300 may be housed inside the armor assembly 230.

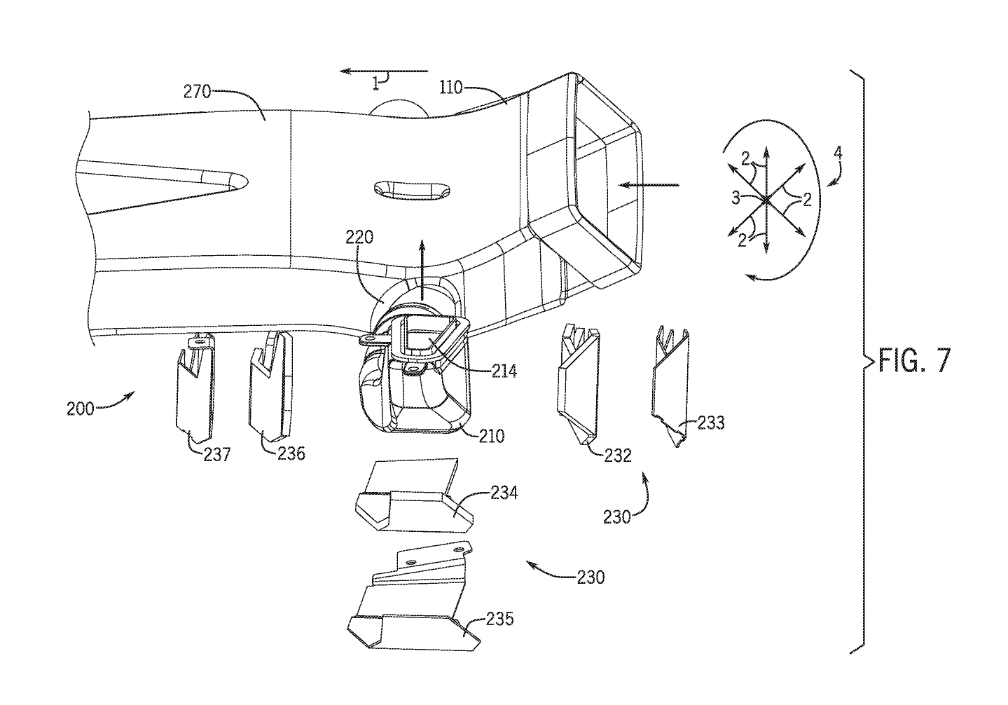

FIG. 7 is an exploded side view of the duct assembly 200 of FIG. 6. The HVAC compartment 270 includes an HVAC compartment opening 110, which may receive fluid (e.g., air) from the ambient and direct the fluid to the inlet duct 220. Further, the inlet duct 220 may direct the fluid along a lateral direction 3 to the fender duct 210 via a first opening of the fender duct 210. The fender duct 210 is configured to direct the fluid along the lateral direction 3 and along a substantially upward radial direction 2, such that the fluid flows out of a second opening 214 along a substantially upward radial direction to the outlet duct.

Furthermore, the illustrated armor assembly 230 includes a two-layer armor arrangement that forms a housing around the fender duct 210 along a circumferential axis 4. In the illustrated embodiment, the armor assembly 230 includes an inner-rearward armor layer 232, an outer-rearward armor layer 233, an inner-lower armor layer 234, and outer-lower armor layer 235, an inner-forward armor layer 236, and an outer-forward armor layer 237. The rearward armor plate set (e.g., collectively, the inner-rearward armor layer 232 and the outer-rearward armor layer 233) is oriented opposite the direction of travel 1 of the work vehicle. The lower armor plate set (e.g., collectively, the inner-lower armor layer 234 and the outer-lower armor layer 235) is oriented substantially in the lower radial direction 2 relative the fender duct 210. The forward armor plate set (e.g., collective, the inner-forward armor layer 236 and the outer-forward armor layer 237) is oriented toward the direction of travel 1 of the work vehicle.

Although no upper armor plate set is included in the illustrated embodiment, in further embodiments, the armor assembly 230 may include a two layer upper armor plate set. In such an embodiment, the fender duct 210 may be fully surrounded by the armor assembly 230 such that the armor assembly may follow the surface of the fender duct 210 along the circumferential axis 4. In additional embodiments, each armor plate set may include any suitable number of layers. Although the illustrated embodiment includes a two layer arrangement, in additional embodiments, there may be a one layer, two layer, four layer, six layer, eight layer, or any other suitable layer arrangement for the armor assembly 230. Furthermore, in additional embodiments, the armor assembly 230 may not include the rear armor plate set, the forward armor plate set, or the lower armor plate set. As such, the armor assembly 230 may include the rear armor plate set, the forward armor plate set, the lower armor plate set, or any combination thereof.

Furthermore, in certain embodiments, each inner armor layer may include any suitable thermal insulating material (e.g., fiberglass, mineral wool, polyurethane foam, polystyrene, etc.) to protect and/or insulate the fender duct 210. In addition, each outer armor layer may include any suitable material with a high Young's Modulus of Elasticity (e.g., brass, copper, steel, etc.) to resist deformation under loads. As mentioned above, in alternative embodiments, the armor assembly 230 (e.g., or any portions of the armor assembly) may be omitted from the duct assembly 200.

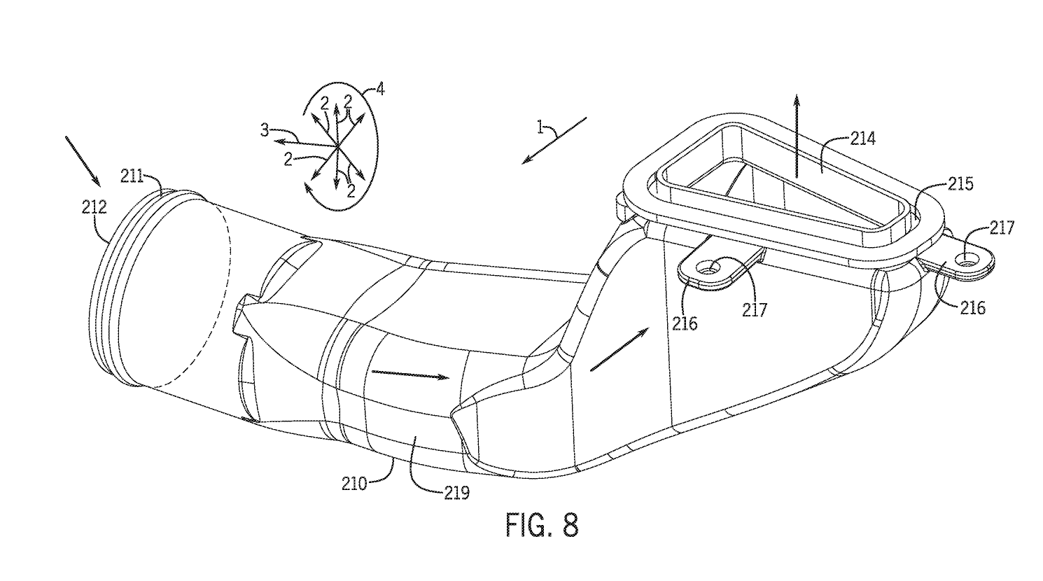

FIG. 8 is a perspective view of an embodiment of a fender duct 210 of the duct assembly 200 of FIG. 6. The fender duct 210 includes a first opening 212, which may receive fluid (e.g., expelled by the HVAC system of the work vehicle) via the inlet duct, as mentioned above. In the illustrated embodiment, the first opening 212 is substantially circular in shape, and oriented in the lateral direction 3. As mentioned above, the fluid may flow into the first opening 212 and be directed along the lateral direction 3. After entering the fender duct 210, the fluid may flow through the fender duct 210, such that the flow path of the fluid may follow the interior shape of fender duct 210. Upon flowing inside the fender duct 210, the fluid may exit the fender duct 210 through the second opening 214 along a substantially radially upward direction 2 toward the outlet duct, as described in detail above. In the illustrated embodiment, the first opening 212 is substantially circular in shape and the second opening 214 is substantially trapezoidal in shape with rounded edges. In alternative embodiments, the first opening 212 may be of any suitable shape (e.g. square, triangle, triangle, etc.). Furthermore, in alternative embodiments, the second opening 214 may be of any suitable shape (e.g., triangular, circular, square, etc.).

In the illustrated embodiment, the fender duct 210 has a curved portion that connects lateral portion of the fender duct 210 to a radial portion of the fender duct 210. That is, the fender duct 210 has a body 219 that extends between the first opening 212 (e.g., at the lateral portion) and the second opening 214 (e.g., at the radial portion). Furthermore, the fender duct 210 is configured to flow fluid between the first opening 212 and the second opening 214. Arrows are included in the illustrated embodiment to illustrate the flow path of the fluid. As mentioned above, the fender duct 210 is configured to receive the fluid along the lateral direction 3 via the first opening 212. The fender duct 210 may then direct the fluid along the substantially (e.g., upward) radial direction 2, such that the fluid flows out of the second opening 214 along a substantially (e.g., upward) radial direction 2 to the outlet duct. In alternative embodiments, the fender duct 210 may be of any suitable shape and may direct the flow of fluid along any suitable direction(s). For example, the fender duct 210 may include a body 219 that is triangular in cross section and is configured to receive fluid along a longitudinal direction and direct it along a radial direction at 45 degrees relative to the vertical direction.

Regarding the methods of coupling the fender duct 210 to the inlet duct and the outlet duct, in illustrated embodiment, the fender duct 210 has threads 211 at the first opening, which may be used to facilitate coupling of the fender duct 210 to the inlet duct. However, in further embodiments, the fender duct 210 may be coupled to the inlet duct via any other suitable method, such as welding, using fittings, brazing, or any other suitable method for joining conduit sections. Furthermore, the fender duct 210 includes an indention 215 at the second opening 214, which receive an outer portion of the outlet duct, thereby coupling the outlet duct to the fender duct 210. Once inserted into the indention 215, the outlet duct may be welded or fixed (e.g., via any suitable joining method) to the fender duct 210, thereby enhancing the strength of the region joining the outlet duct to the fender duct 210. In some embodiments, the outlet duct and the fender duct 210 may be coupled to the chassis 103 (e.g., as illustrated in FIGS. 4 and 5).

Furthermore, the fender duct 210 includes tabs 216 oriented outward from the second opening 214. The tabs 216 include holes 217. The holes 217 may receive bolts that may extend through corresponding openings in the chassis 103 (e.g., which may support the HVAC compartment 270), thereby coupling the fender duct to the chassis 103.

While only certain features have been illustrated and described herein, many modifications and changes will occur to those skilled in the art. It is, therefore, to be understood that the appended claims are intended to cover all such modifications and changes as fall within the true spirit of the disclosure.

1. A duct assembly for a work vehicle, comprising:
a fender duct comprising a body that extends between a first opening and a second opening, wherein the fender duct is configured to flow fluid between the first opening and the second opening, and the fender duct is positioned on a bottom side of the work vehicle and radially outward from a wheel of the work vehicle; and
an armor assembly positioned radially outward from the fender duct, wherein the armor assembly is configured to form a housing around the fender duct.

2. The duct assembly of claim 1, wherein the first opening of the fender duct has a cross sectional shape that is different from a cross sectional shape of the second opening of the fender duct.

3. The duct assembly of claim 2, wherein the cross sectional shape of the first opening of the fender duct is substantially circular, and the cross sectional shape of the second opening of the fender duct is substantially trapezoidal.

4. The duct assembly of claim 1, wherein the armor assembly comprises a plurality of layers.

5. The duct assembly of claim 1, wherein the armor assembly comprises a first armor plate set, a second armor plate set, and a third armor plate set, wherein the first, second and third armor plate sets are configured to form the housing around a portion of the periphery of the fender duct, the first armor plate set is positioned forward of the fender duct along a direction of travel on the bottom side of the work vehicle, the second armor plate set is positioned rearward of the fender duct along the direction of travel of the work vehicle, and the third armor plate set is positioned under the fender duct.

6. The duct assembly of claim 5, wherein at least one of the first, second, and third sets of armor plate sets comprise a first plate and a second plate, wherein the first plate is positioned radially outward from the fender duct, and the second plate is positioned radially between the fender duct and the first plate.

7. The duct assembly of claim 1, comprising an inlet duct configured to couple to the first opening of the fender duct, wherein the inlet duct is configured to route fluid into the first opening of the fender duct.

8. The duct assembly of claim 7, comprising an outlet duct configured to couple to the second opening of the fender duct and route the fluid out of the fender duct via the second opening of the fender duct.

9. The duct assembly of claim 8, wherein the inlet duct is configured to direct the fluid into the fender duct along a substantially lateral direction, and the outlet duct is configured to direct the fluid out of the fender duct in a radially outward direction.

10. The duct assembly of claim 1, wherein the fender duct is configured to block debris from engaging electrical connectors positioned on an opposite side of the fender duct from the wheel.

11. A duct assembly for a work vehicle, comprising:
a fender well comprising a portion of a bottom side of a chassis of the work vehicle, wherein the bottom side of the chassis comprises electrical connectors and the electrical connectors are positioned rearward of the fender well;
a fender duct comprising a body that extends between a first opening and a second opening, wherein the fender duct is configured to flow fluid between the first opening and the second opening, and the fender duct is positioned on a bottom side of a chassis of the work vehicle and radially outward from a wheel of the work vehicle;
an inlet duct coupled to the first opening of the fender duct; and
an outlet duct coupled to the second opening of the fender duct.

12. The duct assembly of claim 11, wherein the fender duct comprises a portion of the fender well.

13. (canceled)

13. The duct assembly of claim 11, comprising an armor assembly positioned radially outward from the fender duct, wherein the armor assembly configured to form a housing around the fender.

14. The duct assembly of claim 13, wherein the electrical connectors are positioned on the bottom side of the chassis of the work vehicle forward of the armor assembly.

15. The duct assembly of claim 14, wherein the electrical connectors comprise inductors, sensors, power lines, electrical wiring, transceivers, or any combination thereof.

16. The duct assembly of claim 13, wherein the armor assembly comprises a first plate set, a second plate set, and a third plate set, wherein the first, second and third plate sets are configured to form the housing around a portion of the periphery of the fender duct, the first plate set is positioned forward of the fender duct along a direction of travel on the bottom side of the work vehicle, the second plate set is positioned rearward of the fender duct along the direction of travel of the work vehicle, and wherein the third plate set is positioned under the fender duct.

17. The duct assembly of claim 11, wherein the inlet duct is configured to direct the fluid into the fender duct along a substantially lateral axis, and the outlet duct is configured to direct the fluid out of the fender duct in a radially outward direction.

18. A duct assembly for a work vehicle, comprising:
a fender well comprising a portion of a bottom side of a chassis of the work vehicle, wherein the bottom side of the chassis comprises electrical connectors and the electrical connectors are positioned forward of the fender well;
a fender duct comprising a body that forms a portion of the fender well, wherein the body is configured to extends between a first opening and a second opening and flow fluid between the first opening and the second opening, and the fender duct is positioned on a bottom side of a chassis of the work vehicle and radially outward from a wheel of the work vehicle;
an inlet duct coupled to the first opening of the fender duct; and
an outlet duct coupled to the second opening of the fender duct.

19. The duct assembly of claim 18, wherein the inlet duct is configured to receive the fluid from a heating, ventilation, and air conditioning (HVAC) system and direct the fluid into the first opening of the fender duct.

20. The duct assembly of claim 18, wherein the outlet duct is configured to receive the fluid via the second opening of the fender duct and direct the fluid to a valve.
